(19) United States
(12) Patent Application Publication
(10) Pub. No.: US 2005/0012894 A1
(43) Pub. Date: Jan. 20, 2005

(54) System and method for dynamic contact angle measurement

(76) Inventors: Howard Allen Ketelson, Fort Worth, TX (US); David L. Meadows, Colleyville, TX (US)

Correspondence Address: ALCON RESEARCH, LTD., R&D COUNSEL, Q-148, 6201 SOUTH FREEWAY, FORT WORTH, TX, 76134-2099, US

(21) Appl. No.: 10/891,367

(22) Filed: Jul. 14, 2004

Related U.S. Application Data
(60) Provisional application No. 60/486,940, filed on Jul. 14, 2003.

(51) Int. Cl. G02C 7/04; H04B 10/00

(52) U.S. Cl. 351/160 R

(57) ABSTRACT

A system and method for dynamic contact angle measurement on a curved material are disclosed. One embodiment of the method comprises: initializing a video-based contact angle measuring apparatus; preparing the curved material for contact angle measurement; performing a sessile drop procedure to deposit a drop of liquid on the curved material; capturing an image of the drop on the curved material at a preset time; determining a drop-curved material interface on the image; determining a drop profile on the image; and calculating a set of dynamic contact angles based on the drop-curved material interface and the drop profile. The contact angle measuring apparatus can further comprise a processor for executing software instructions, a software module comprising processor-executable software instructions for performing at least some of the steps of the method and a memory, operably coupled to the processor, for storing the processor-executable software instructions. Further, the steps of determining the drop-curved material interface, determining the drop profile, capturing an image, initializing the contact angle-measuring apparatus and calculating the set of dynamic contact angles can each be at least partially performed via software running on the processor. The contact angle measuring apparatus can also include a camera and a digital frame-grabber for capturing an image. As a further aspect of the present invention, the curved material can be a hydrogel contact lens either mounted on an external sample stage or in a patient's eye for in vivo contact angle measurements.

This application claims priority from U.S. Ser. No. 60/486,940 filed Jul. 14, 2003.

### TECHNICAL FIELD OF THE INVENTION

The present invention relates generally to the field of materials property measurement. In particular, the present invention relates to dynamic contact angle measurement to determine the wettability of a material, such as a hydrogel, in near real-use conditions.

### BACKGROUND OF THE INVENTION

Hydrogels are polymers that comprise water insoluble three dimensional networks that can absorb high water concentrations and are used in a variety of biomedical fields. A hydrogel matrix typically contains a large number of hydrophilic groups (e.g., hydroxyl, carboxyl and amide) that give rise to the hydrophilicity of the polymer. The most well known hydrogel for use in biological fields is poly (2-hydroxyethyl methacrylate or “pHEMA”) and one of its most notable applications was its use in preparing the first commercial hydrogel contact lens. Since that time, efforts have been on-going to understand the biocompatibility properties of hydrogels. Today, a popular contact lens material is the Acuvue 2 (“Acuvue”) (manufactured by Vistakon) lens which comprises the polymer Etafilcon A, poly [2-hydroxyethyl methacrylate-co-methacrylic acid]. This lens has a water content of 58%.

In the case of a hydrogel contact lens, the interaction between the tear film and the contact lens surface affects the physiological response of the cornea and the eyelids to the contact lens. A wettable lens surface is necessary for the tear film to efficiently spread on the surface and thus reduce the friction between the eyelid and the contact lens. A wettable contact lens will also provide for a more stable tear film. Typically, the less wettable the surface of a contact lens, the greater the patient discomfort. In vitro studies have shown that the properties of hydrogel surfaces change from hydrophilic to hydrophobic when exposed to air resulting in a less wettable surface. This transition is believed to result from the reorientation of the surface hydrophilic groups towards the inner bulk portion of the hydrogel, in concert with reorientation of hydrophobic groups towards the surface.

There have been few systematic studies carried out on intact soft contact lenses to measure the wettability of the lens materials. One of the drawbacks in using a contact lens as the substrate in contact angle measurements is the inherent curved nature of the material. Researchers have previously cut the contact lenses into strips and obtained dynamic contact angles of lenses using a Wilhelmy plate technique. The capability to directly measure contact angles on contact lenses, either removed directly from the eye (ex vivo) or in the eye (in vivo), without destroying or deforming the lenses would be a significant tool in understanding the wettability properties of contact lenses and improving their biocompatibility properties.

Therefore, a need exists for a system and method to measure dynamic contact angles of a curved material in near real-use conditions. In particular, a need exists for such a method that will provide the ability to track the same piece of material (e.g., the same contact lens) over time and provide the ability to compare differences among lens materials and soaking solutions with reproducibility. Such a technique can facilitate optimization of contact lens materials and storage solutions. More immediately, it may help clinicians troubleshoot the selection of lens materials and soaking solutions to improve contact lens comfort for a patient.

### BRIEF SUMMARY OF THE INVENTION

The embodiments of the system and method for dynamic contact angle measurement on a curved material of this invention substantially meet the above-identified needs, as well as others. One embodiment of the method comprises: initializing a video-based contact angle measuring apparatus; preparing the curved material for contact angle measurement; performing a sessile drop procedure to deposit a drop of liquid on the curved material; capturing an image of the drop on the curved material at a preset time; determining a drop-curved material interface on the image; determining a drop profile on the image; and calculating a set of dynamic contact angles based on the drop-curved material interface and the drop profile. Initializing the contact angle measuring apparatus can comprise inputting a set of calculation parameters to a software module of the contact angle measuring apparatus, wherein the set of calculation parameters can comprise a drop phase density, the needle size of a needle delivering the drop, aspect ratio, a dosing rate and a dosing volume.

The contact angle measuring apparatus can further comprise a processor for executing software instructions, a software module comprising processor-executable software instructions for performing at least some of the steps of the method and a memory, operably coupled to the processor, for storing the processor-executable software instructions. Further, the steps of determining the drop-curved material interface, determining the drop profile, capturing an image, initializing the contact angle-measuring apparatus and calculating the set of dynamic contact angles can each be at least partially performed via software running on the processor. The contact angle measuring apparatus can also include a camera and a digital frame-grabber for capturing an image. As a further aspect of the present invention, the curved material can be a hydrogel contact lens either mounted on an external sample stage or in a patient's eye for in vivo contact angle measurements. For in vivo measurements, the contact angle measuring apparatus can further comprise a head support for positioning the head of a subject wearing the contact lens.

An embodiment of the system for determining a dynamic contact angle on a curved material of this invention can comprise: a sessile drop apparatus for depositing a drop of liquid on the curved material; a video capture system for capturing an image of the drop on the curved material at a preset time; a software module, comprising processor-executable software instructions for performing at least some of the steps of determining the dynamic contact angle; a processor for executing the processor-executable software instructions to determine the dynamic contact angle; a memory, operably coupled to the processor, for storing the processor-executable software instructions; and a user interface, operably coupled to the processor and to the memory, for inputting a plurality of calculation parameters for use by the processor-executable software instructions. The sessile drop apparatus can further comprise a sample stage for holding the curved material and a dosing needle, operable to provide and maintain a controlled drop and a drop dosing rate.

### BRIEF DESCRIPTION OF THE SEVERAL VIEWS OF THE DRAWINGS

A more complete understanding of the present invention and the advantages thereof may be acquired by referring to the following description, taken in conjunction with the illustration of certain preferred embodiments in the accompanying drawings, in which like reference numbers indicate like features and wherein:

FIG. 1 is a flowchart illustrating the steps of one embodiment of the method of this invention;

FIG. 2 is a graph showing the surface tension values of a Unisol solution containing an Acuvue® lens;

FIG. 3 is a graph showing the contact angles of water in air as a function of cycles;

FIG. 4 is a graph illustrating mean advancing dynamic contact angles of water on an Acuvue® lens as a function of cycling exposures at 1.5 minutes air exposure;

FIG. 5 is a graph illustrating mean advancing dynamic contact angles of water on an Acuvue® lens as a function of cycling exposure at 5 minute air exposures;

FIG. 6 is a graph showing average mean advancing dynamic contact angles of water using the data of FIGS. 4 and 5;

FIG. 7 is a graph comparing mean advancing contact angles of water on lenses soaked in different surfactants;

FIG. 8 is a graph illustrating the mean advancing contact angles of a water drop on an Acuvue® lens as a function of cycling for lenses soaked in various disinfecting solutions;

FIG. 9 is a series of video images illustrating the sessile drop method; and

FIG. 10 is a simplified block diagram illustrating one embodiment of the system of this invention.

### DETAILED DESCRIPTION OF THE INVENTION

The embodiments of the system and method of this invention provide for measuring the wettability of a material in near real-use conditions. Unlike prior art techniques, the embodiments of the invention described herein are adapted for measuring dynamic contact angles on curved materials, and, in particular, on the curved surface of a contact lens. In accordance with the present invention, these measurements can be made ex-vivo on an intact contact lens under conditions simulating the conditions that exist in a wearer's eye. Alternatively, in-vivo measurements can be made on a contact lens while worn by a patient. The ability to measure dynamic contact angles, and hence wettability, of a contact lens under real-use or near real-use conditions greatly enhances the ability to develop wettable materials. Further, ex-vivo results can be correlated to the more accurate in vivo measurements, making for more accurate ex-vivo measurements. In particular, contact lens wearers and clinicians will benefit from the improved comfort and biocompatibility of materials selected and/or developed using the measuring technique taught by the present invention.

A key aspect of the embodiments of this invention is the reproducibility of the measurement method. Contact angle measurements in accordance with this invention can be used to follow changes in contact lens wettability properties following cycling regimens that are near to those experienced during wear. These conditions can be simulated by cycles comprising a Unisol (buffered saline) soak and air exposure. The effect of lens water content and the possible release and influence of surface active species used in the lens packing solution was evaluated to determine if these variables could influence the contact angle measurements.

Embodiments of the present invention comprise an optical contact angle measuring device modified with software to calculate a contact angle on a curved surface. In this way, the contact angles on a contact lens can be measured directly. The system and method taught by the present invention were evaluated by measuring contact angles on lenses that were cycled using physiological saline/air soak cycles and tracking the dynamic contact angle changes. Various conditions and differing cycles were performed, as described more fully below.

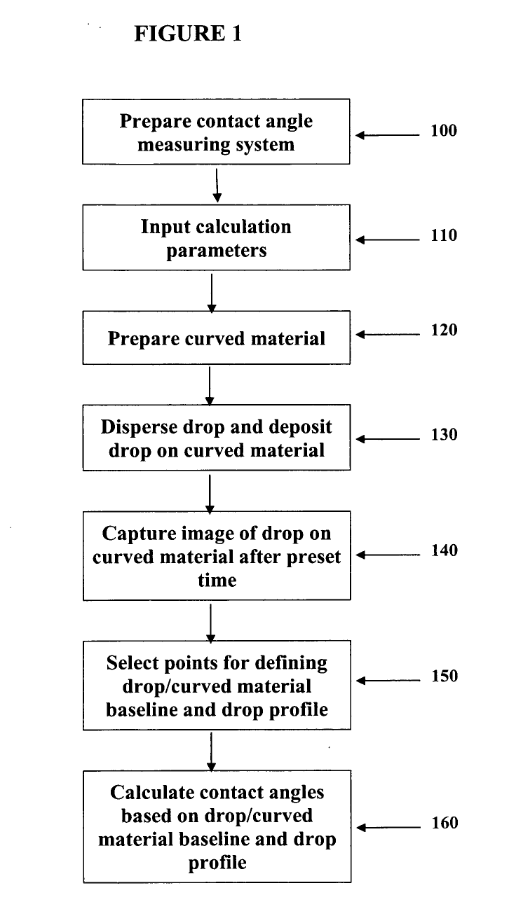

One embodiment of the present invention is directed to a method for measuring dynamic contact angles using a video-based contact angle measuring system. This system can be any suitable contact angle measuring system as known to those familiar with the art, such as the OCA 20 system manufactured by Future Digital Scientific Corporation of Bethpage, N.Y. The contact angle measuring system is modified to include curve-fitting software to allow for direct contact angle measurements on a curved surface. Such software is known in the art. A user interface for entering various parameters and for viewing results is also provided. FIG. 1 is a flow chart illustrating the steps of an embodiment of the invention.

At step 100, the contact angle measuring system is prepared for use. For example, an OCA 20 is turned on and the syringe is filled with water and connected to a dosing needle for administration of a drop. At a user interface, the video camera is initiated via software to begin image capture. On the system, a user can adjust horizontal and vertical knobs on a needle holder and a zoom lens knob for the video camera, until the needle tip is at a preferred image capture position. A fine focus knob on the camera and an illumination knob at the light source can be adjusted to obtain a sharp image of the needle.

At step 110, a user inputs calculation parameters into the software via the user interface. These parameters can include “drop phase” density, needle size, and aspect ratio. These parameters are used to calculate the contact angles. The user can also set the dosing rate and dosing volume to be used for drop dose via the software user interface.

At step 120, a contact lens or other curved material is prepared and mounted. The contact lens is removed from the saline soak solution and inverted on a clean lens tissue paper with its anterior side in contact with the tissue for a time period sufficient to wick away excess solution, for example, for 30 seconds. The contact lens (anterior side facing needle) is placed on a lens support button using tweezers and the lens support is placed on the sample stage. The user can then adjust illumination and magnification to obtain a sharp image of the drop and the sample contact lens.

Via the user interface and software, at step 130 a drop is dispersed and allowed to hang at the tip of the needle until it reaches an equilibrium state. The sample stage is then raised to catch the drop with the contact lens. After about 5 to 10 seconds, at step 140, an image of the drop on the lens surface is captured.

At step 150, the user determines, via the software, the baseline of the drop on the curved contact lens surface by manually selecting the two outermost spots (left and right) of the drop image, at the user interface. The user can then select additional points along the drop-contact lens interface to further define the baseline. The software will generate a curved baseline when sufficient points along the curved surface are selected. The profile of the drop on the curved lens surface is determined by selecting at the user interface the two outermost spots (again) and then selecting the topmost spot (apex) of the drop image via, for example, an input device such as a mouse or other such device (likewise for the drop baseline). The software will generate a drop profile when sufficient points along the curved surface are selected. The user can select additional points as needed and enter them into the software in the manner described above for the outmost two spots.

At step 160, the software is used to calculate the contact angle of the drop on the contact lens based on the provided inputs. The contact angle is provided to the user at the user interface.

The above-described system and method are easily reproducible and provide a quick, efficient and accurate means for determining a contact angle on a curved surface. The system and method of the present invention are further illustrated by means of the various examples described below.

Table 1 shows the lens water content results following various cycling experiments on lenses used to evaluate the system and method of this invention. The manufacturer-listed water content for the Acuvue® lens is 58% and the base curve and lens diameter are 14.0 mm and 8.7 mm respectively. A slightly lower water content of 55.4±1.7% was obtained using a gravimetric method. Table 1 shows that after cycling the lenses 3 (AV-2A), 8 (AV-2B) and 13 (AV-2C) times, the % water contents were 57.4%, 57.6% and 56.1%, respectively. These values were within an acceptable range of a control lens (e.g., 55.4±1.7%) and the results indicate that the cycling regimen did not significantly change the lens water content. In another experiment (AV-3A), a new lens was immersed in Unisol for 24 hours followed by soaking the lens through 4 cycles in fresh Unisol solutions. In this case the lens water content was determined to be 56.8%. Another lens (AV-3B) was put through the same regimen as AV-3A, but after the soak cycles the lens was cycled 4 times (i.e., 4×5 minute Unisol/1.5 minute air). The water content of the lens was determined to be 54.8%. These results indicate that no significant water loss occurs during the lens cycling and soaking regimens.

TABLE 1
Water Content of Acuvue ® lenses
as determined by Gravimetric Analysis.

| Lens | Lens Description | % H₂O |
|---|---|---|
| AV-1 | Control lens out of pack | 55.4 ± 1.7 |
| AV-2A | 3 cycles | 57.4 |
| AV-2B | 8 cycles | 57.6 |
| AV-2C | 13 cycles | 56.1 |
| AV-3A | Unisol replaced after 24 hour soak (1/day) for | 56.8 |
| | 4 total days | |
| AV-3B | Unisol cycled 4 days + 4 cycles | 54.8 |

The presence of residual surface surfactant and surfactant within the lens matrix are factors that could contribute to contact angle changes. Contact lens packing solutions can contain surfactants to prevent lenses from sticking together. The leaching out of surfactant from the lens could influence the lens wettability properties. Surface tension measurements have been used previously to monitor surfactant release from contact lenses.

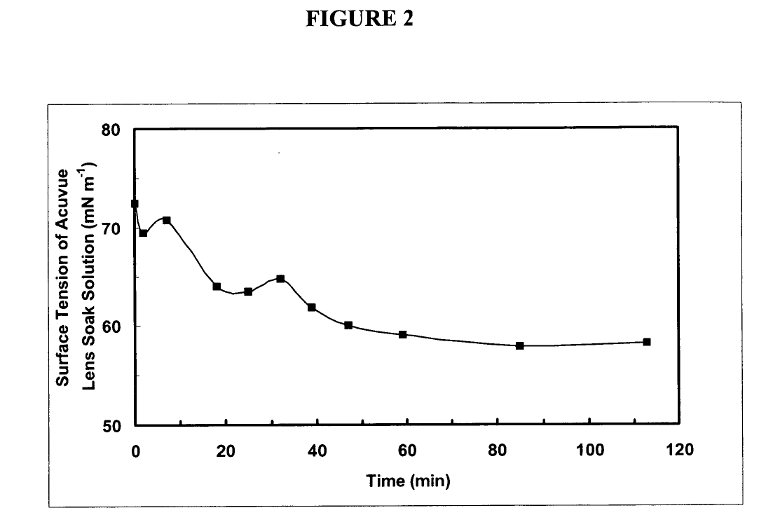

FIG. 2 shows the surface tension data of a Unisol solution containing an Acuvue® lens. The lens was rinsed two times for 30 seconds to remove excess surfactant and subsequently placed in the Unisol solution. The surface tension data shown in FIG. 2 are plotted as a function of time. As seen from FIG. 2, the surface tensions of the soaking solution decreased over the time frame of the experiment. This trend indicates that surfactant leached out from the lens. For example, a fresh Unisol solution had a surface tension of 72.7±0.2 mN m⁻¹, but within 60 minutes of soaking the lens, the surface tension of the Unisol soak solution decreased to 59.1 mN m⁻¹. Following the 60 minute time frame, the surface tension did not significantly change. Further experiments using contact angle measurements were used to evaluate the effect of surfactant release.

As described above, the influence of lens cycling over time on lens wettability was evaluated using the sessile water drop technique. Lens cycles comprised of 5 minute Unisol soak and 1.5 minute air time were used. After each cycle the contact angle of a water drop on the lens was measured. The data points in each of the plotted curves are the average of three manual calculations of the same water drop using the curve-fitting software. Since only one drop can be made on each lens, the reproducibility of the technique was evaluated by carrying out the water drop determinations on several lenses.

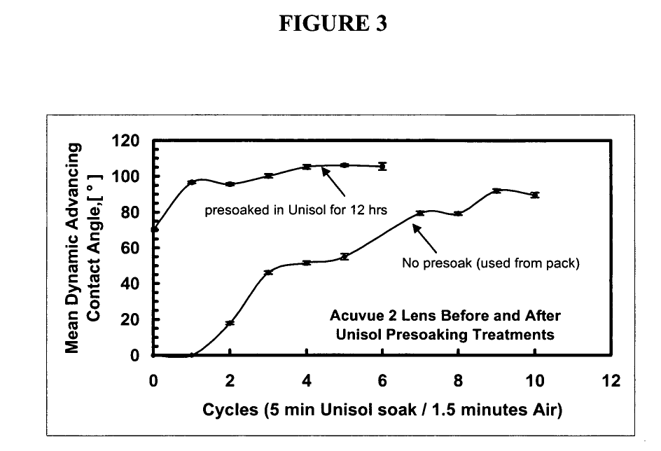

FIG. 3 shows the contact angles of water in air as a function of cycles for two lens treatment cases. In one case, the lens was presoaked for 12 hrs in Unisol to leach out residual surfactant before taking the measurements. In the other case, the contact angles were measured without any lens presoaking treatment (e.g., the lenses were taken directly from their packing). For the presoaked lens case, the contact angles increased from 70.2° (cycle 0=lens taken from soaking solution and directly measured after 1.5 minute air exposure) to 96.6° (cycle 1=5 minute Unisol soak+1.5 minute air time). As the number of cycles increased, the contact angles measured reached a plateau corresponding to values of approximately 105°. The same presoaked lens after cycle 6 was placed in a fresh Unisol solution and left in the solution for 1 week before another measurement was taken. The contact angle did not change after this treatment.

The above results indicate that presoaking the lens in Unisol caused rapid dewetting effects. In the case of the lenses that were not presoaked, FIG. 3 shows that the initial contact angles were low and wetting conditions were observed. On the other hand, as the lens was cycled from cycle 1 through cycle 10, significant contact angle increases were observed. For example, the contact angles increased from 17.9° to 51.5° as the cycle number increased from 2 to 4. Similarly, the contact angles increased from 55° to 89.7° as the cycle number increased from 5 to 10. The rapid rise in contact angles is believed to reflect the leaching out of the surfactant from the lens, a view supported by the surface tension data (FIG. 2). The contact angle data in FIG. 3 suggests that the surfactant used in the lens packaging solution is not a good wetting agent, and dewetting conditions would be expected with this surfactant, regardless of the lens presoaking treatment.

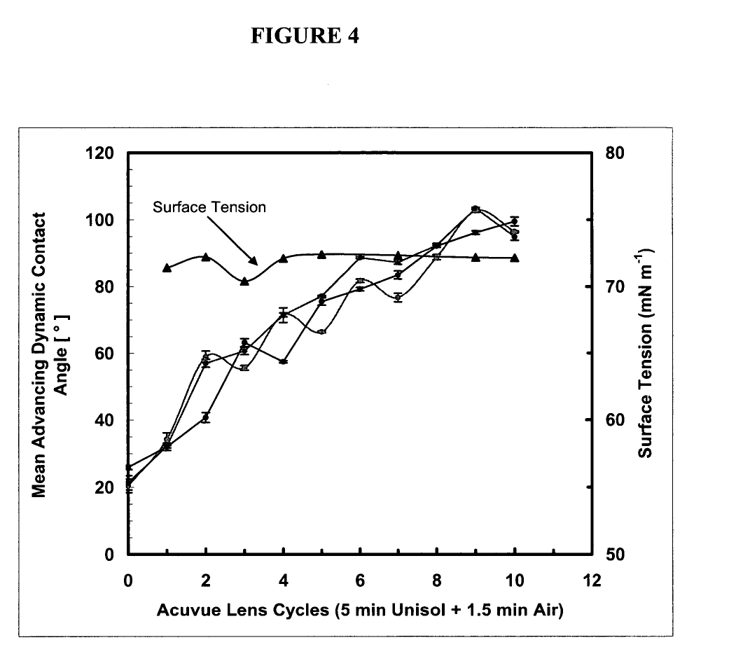

Additional contact angle measurements were performed to evaluate the reproducibility of the embodiments of the method of this invention. The lens being measured was pretreated by simply rinsing for 30 seconds in Unisol to remove excess surfactant from the lens' packaging material. This was done to more closely simulate a contact lens care regiment in a clinical setting. Independent measurements of three lenses are shown in FIG. 4 using 5 minute Unisol and 1.5 minute air cycles. The contact angles were typically within ±3°. The contact angles typically increased with each cycle, indicating a trend towards poor wetting conditions after 3-4 cycles. The contact angles of the lenses were observed to increase towards 100° after 9-10 cycles.

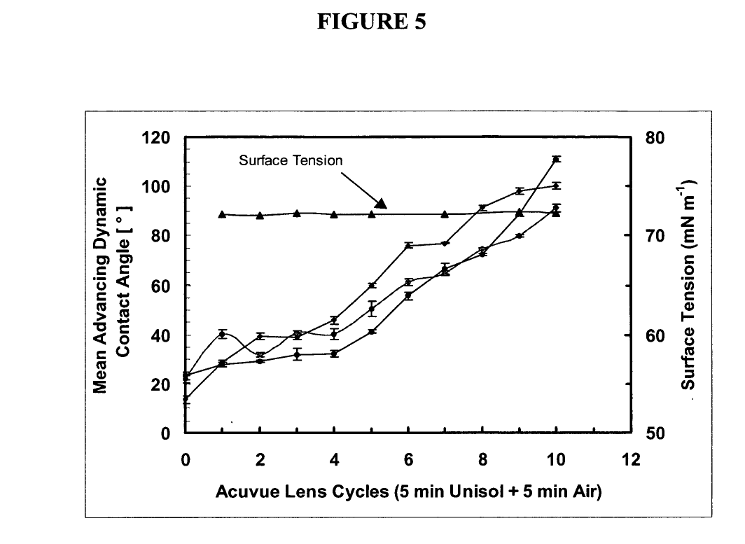

To further evaluate the wetting behavior of water on the contact lenses, the air time exposure was increased from 1.5 minutes to 5 minutes. FIG. 5 shows the plots of the water drop contact angles following 5 minute Unisol and 5 minute air time cycles. The surface tensions of the soak solutions are also plotted to show that no changes in the values were observed under the conditions used. FIG. 5 shows the contact angle plots of three lenses and the results follow a similar trend to that observed using the shorter air time cycles (FIG. 4). The main difference observed between the air exposure times is the suppressed dewetting phenomena using the 5 minute air exposure from cycle 0 through cycle 5. The 5 minute air time exposure appears to slow down the rate of dewetting relative to that using the 1.5 minute air time. To show this effect more clearly, the contact angle results from FIGS. 4 and 5 were re-plotted by averaging the mean contact angles obtained for each cycle.

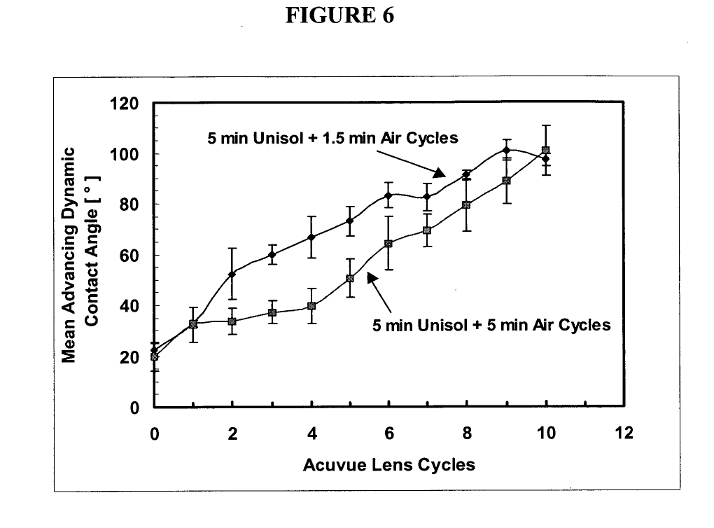

FIG. 6 shows the re-plotted data and also provides the standard deviations for each of these averaged values. The contact angle differences ranged between 20-30° and were statistically significant between cycles 2 through 5.

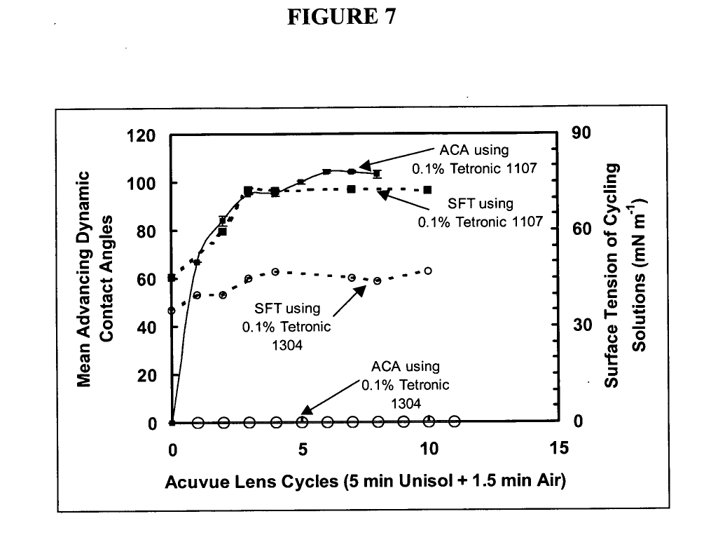

The influence of surfactant on the contact lens material wettability properties was evaluated using an Acuvue® lens and two well known non-ionic block copolymer surfactants, Tetronic® 1304 and Tetronic® 1107. FIG. 7 compares the contact angles of water drops on lenses that were presoaked in 0.1% Tetronic® 1304 and 0.1% Tetronic® 1107. The physical and chemical properties associated with these surfactants are provided in Table 2 below. The contact angle plots show that the lenses soaked in 0.1% Tetronic® 1304 had complete wetting properties (i.e., zero contact angle). Comparatively, the contact angles measured on the lenses soaked in the Tetronic® 1107 solution showed rapid contact angle increases (i.e., dewetting) after the first cycle. For example, the contact angle increased from 0° to 95.2° following only 3 cycles. The contact angle changes were less significant following further increases in the cycling. For example, the contact angles at cycle 5 and cycle 8 were 99.8±0.7 to 103.1°±1.6, respectively. The surface tensions of the cycling solutions were also measured following the contact angle measurements.

TABLE 2
Physical properties of Tetronic ® block copolymers
used for soaking the pHEMA-MAA lenses. The data is
taken from the BASF Performance Chemicals catalogues
(1996) Pluronic ® and Tetronic ® Surfactants.
(PEO = poly(ethyleneoxide))

| | Average | | | |
|---|---|---|---|---|
| | Molecular | | | |
| | Weight | | Cloud Point | |
| Surfactant | (g mol⁻¹) | PEO wt % | (° C.) | HLB* |
| Tetronic 1107 | 15000 | 70 | >100 | 24 |
| Tetronic 1304 | 10500 | 40 | 85 | 14 |

*HLB = hydrophilic - lipophilic balance

FIG. 7 shows the surface tension (SFT) data plotted as a function of the cycles for the lenses that were pre-soaked in the 0.1% Tetronic® 1304 and 0.1% Tetronic® 1107 solutions. The surface tensions using the Tetronic® 1107 showed a rapid increase from 45.3 mN m⁻¹ to 72.6 mN m⁻¹ as the cycles increased from 0 to 3. This rapid rise in surface tension followed the increasing trend of the contact angle results. Comparatively, the surface tension results for the cycling solutions based on Tetronic® 1304 increased very slowly from 35 mN m⁻¹ to 40 mN m⁻¹ after 1 cycle and the values remained relatively consistent between 40-47 mN m⁻¹ during the remaining cycles. The lower values of surface tension (relative to the Tetronic® 1107 results) indicate that there was a very slow release of Tetronic® 1304 from the lens during the cycling time frame. This effect suggests that there was a stronger interaction between the Tetronic® 1304 and the Acuvue® lens relative to that using the Tetronic® 1107.

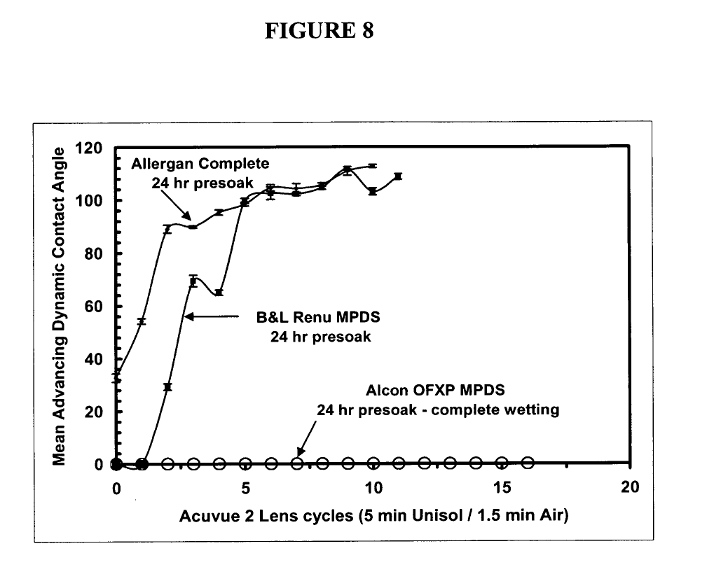

The influence on the contact angles of water on the contact lenses was evaluated by presoaking the contact lenses in marketed contact lens care solutions. The lenses were taken directly from their packaging and presoaked in a multipurpose disinfecting solution (MPDS) for 24 hrs. The following solutions were used: Alcon Opti-Free® Express® (OFXP; Alcon Laboratories, Inc.), Renu® MultiPlus Multi-purpose Solution (Bausch & Lomb) and Complete® Multi-purpose Solution (Allergan). The contact angles of the presoaked lenses as a function of the number of cycles are plotted in FIG. 8. The lenses soaked in the Allergan (Complete®) and Bausch & Lomb (Renu®) solutions showed significant contact angle increases. For example, the contact angles increased from 32.7° to 89.1° after only 2 cycles for the lenses that were presoaked in the Allergan solution. For lenses presoaked in the Bausch & Lomb solution, the contact angle increased from zero (complete wetting) to 69.5 following 3 cycles. Comparatively, the contact angles of water on the lenses presoaked in Alcon's OFXP solution showed complete wetting through 16 cycles. The Alcon OFXP solution contains Tetronic® 1304 and the low contact angle results in FIG. 8 are supported by the studies carried out using surfactant in the buffered saline solutions (FIG. 7).

Ex vivo experiments were carried out using various lens presoaking solutions. The lenses were removed from the eye and placed in buffered saline for 5 minutes followed by a 1.5 minute air time before the measurement. The ex-vivo contact angle results are shown in Table 3 below. The water drop contact angles on the control lenses (no presoaking) from the left and right eyes were 106° and 101°, respectively. These high contact angles indicate a significant reduction in lens wettability. Similar results were observed for the lenses using the marketed solution Renu® MPDS, where contact angles of 112° and 115° were measured on the left and right lenses, respectively. These results were consistent with data for the 0.1% Tetronic® 1107 presoaked lenses which gave poor wetting (i.e., 72° and 89° for left and right eyes, respectively). Lenses presoaked in the Alcon OFXP solution had low contact angles of 22° and 18° for the left and right lenses, respectively. These results indicate that the lenses retained their original wettability throughout the 7 hour wear period. These results were consistent with the 0.1% Tetronic® 1304 presoaked lenses which had excellent wetting (i.e., zero contact angles). The ex vivo measurements showed differences in the contact angles measured on human worn lenses. The type of surfactant used plays an important role in the wettability of the lens surface. The ex vivo measurements correlated with the contact angles observed in the in vitro model studies.

TABLE 3
Ex Vivo Study
Lens Solutions Used to Presoak Lens and
the Dynamic Contact Angle Results

| | | Water Contact |
|---|---|---|
| Test Solution for lens | Water Contact Angle | Angle on |
| presoak | on Lens From Left Eye | Lens From Right Eye |
| Control* - no presoak | 106° ± 0.2° | 101° ± 3° |
| 0.1% Tetronic ® 1304 | 0° | 0° |
| 0.1% Tetronic ® 1107 | 72° ± 1° | 89° ± 0.3° |
| Alcon OFXP MPDS | 22° ± 2° | 18° ± 3° |
| B&L Renu MPDS | 112° ± 1° | 115° ± 1° |

*Control = lens used directly from packaging

The embodiments of the system and method of the present invention were experimentally evaluated using the materials and methods presented below, which are presented for exemplary purposes.

Water Content Determination of Acuvue 2 Lenses

Acuvue® 2 lenses were soaked in 10 ml Unisol for 5 minutes, then placed on a lens paper to drain excess Unisol, followed by placement on a contact lens mount for a total of 1.5 minutes to simulate in vitro conditions used for the contact angle measurements. This process constituted one cycle. After each cycle, the lens was placed back into the Unisol to start the next cycle. Unisol was not replaced during this cycling process. In some cases, lenses were preconditioned to remove surfactant by soaking in 10 ml Unisol then periodically replacing the Unisol with fresh Unisol. The Unisol was replaced several times. These lenses were designated “Unisol cycled”.

Four control lenses were used as comparison. The water content of the control lenses was determined by removing each lens from solution, patting the lens dry with lens tissue to remove surface solution, placing the contact lens in a 20 ml polystyrene cup and then weighing the lens and cup. This is the “wet weight” of the lens. The lens was then placed in a 50° C. oven overnight to dry the lens. The cup and lens were then weighed. Percent water content was determined by the following formula:
[1−(dry lens weight/wet lens weight)]×100=% H₂O content Equation 1
Lens Parameters

Using tweezers an Acuvue® 2 lens was taken directly from the lens pack, placed on lens tissue paper for 30 seconds and then inverted and mounted on a lens holder for one minute. The lens was then removed and its base curve and diameter were measured using an Optimec Contact Lens Dimension Analyzer manufactured by Optimec, Ltd. of Malvern, Great Britain. The lens was subsequently placed in a Unisol solution for 5 minutes. This process constituted one cycle.

TABLE 4
Lens Parameters for Acuvue ® Lenses after Cycling

| | Control lens | | | | | |
|---|---|---|---|---|---|---|
| | (no soak) | | 0.1% Tetronic 1304 | | 0.1% Tetronic 1107 | |
| Cycle | BC | Diameter | BC | Diameter | BC | Diameter |
| Initial | 8.7 | 14.25 | 8.9 | 14.40 | 8.85 | 14.35 |
| 1 | 8.65 | 14.25 | 8.9 | 14.40 | 8.8 | 14.35 |
| 2 | 8.65 | 14.25 | 8.8 | 14.40 | 8.8 | 14.30 |
| 3 | 8.65 | 14.25 | 8.9 | 14.35 | 8.8 | 14.30 |
| 4 | 8.7 | 14.25 | 8.85 | 14.30 | 8.75 | 14.30 |
| 5 | 8.7 | 14.25 | 8.85 | 14.35 | 8.75 | 14.30 |

Surface Tension Measurements

Surface tension of purified water and the Unisol solutions before and after lens soaking cycles were measured according to the Wilhelmy plate (platinum-iridium) technique using a tensiometer (DCAT 11) obtained from Future Digital Scientific, Corp/DataPhysics Instruments GmbH of Bethpage, N.Y. The DCAT 11 was mounted on a bench-top isolation table and interfaced to a computer using SCAT software (V.2.2.2.21,). The software enabled automatic and reproducible control of the height position of the sample. The device was set up using a plate immersion depth of 3.00 mm and recording of 5 readings per second (Hz). The surface tensions gradually decreased and reached equilibrium values.

The experiment can be designed to be stopped automatically based on a user-preselectable standard deviation tolerance in the software. A minimum of 75 data points with a standard deviation of 0.02 were taken before each run was stopped. The software then automatically displayed the data as a function of time. Samples were placed in a fluid circulation temperature control unit equipped with an integrated magnetic stirrer that was connected to a water bath. The measurements were made at 23° C. The Wilhelmy plate was washed with acetone and rinsed with distilled water and flamed red-hot before each measurement. The mean surface tension of the purified water used in the contact angle studies was 72.35±0.28 mN m⁻¹.

Dynamic Contact Angle Measurements

The dynamic contact angles were measured using a video based contact angle measuring system (OCA 20) manufactured by Future Digital Scientific, Corp./DataPhysics GmbH of Bethpage, N.Y. The OCA 20 was modified to use software SCA20 (Version 2.1.5 build16). The OCA 20 was mounted on a vibration-isolation table manufactured by Newport (model LW 3030B-OPT). The images of the drops were recorded with a high performance 6× parfocal zoom lens CCD camera using halogen lighting with continuous adjustable intensity for a homogeneous non-hysteresis back lighting. Other camera and lighting combinations as known to those familiar with the art can also be used, as can any comparable video based contact angle measuring system and appropriate curve-fitting software. The drops were captured with a PCI-frame grabber with a maximum processing capability of 132 Mbyte s⁻¹. The samples were mounted on a sample stage with grid markings for reproducing the sample position for each run. The sample stage was adjustable in three axes.

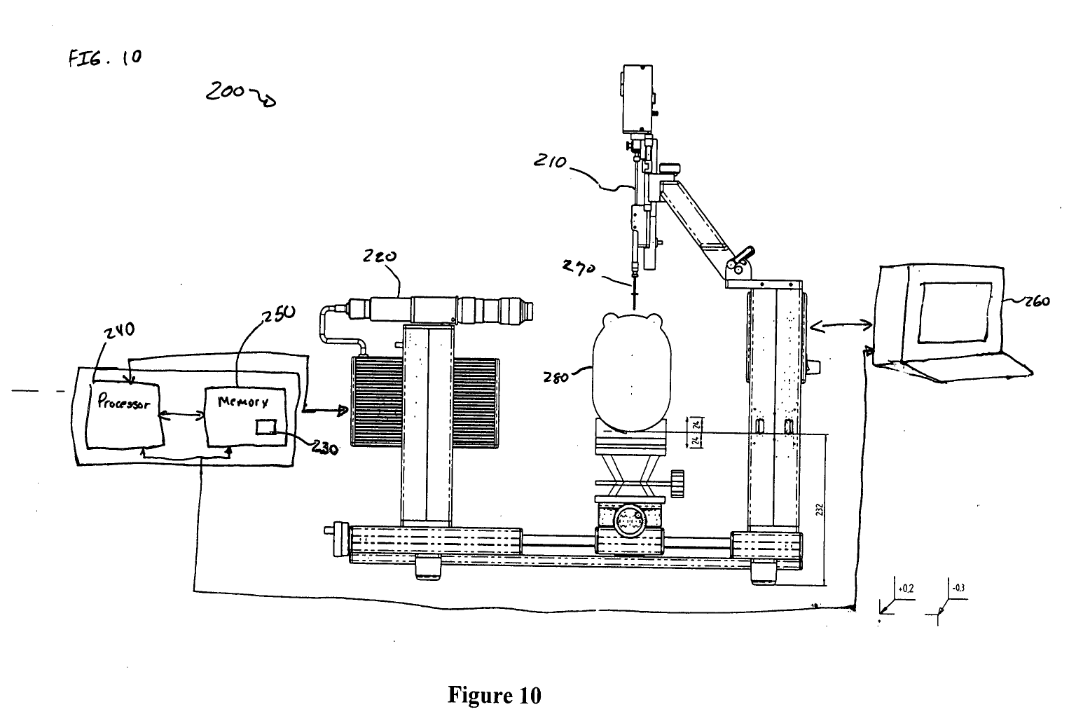

FIG. 10 is a simplified block diagram illustrating an embodiment of a system for determining a dynamic contact angle on a curved material in accordance with this invention. System 200 comprises a sessile drop apparatus 210 for depositing a drop of liquid on the curved material, a video capture system 220 for capturing an image of the drop on the curved material at a preset time, a software module 230, comprising processor-executable software instructions for performing at least some of the steps of determining the dynamic contact angle, a processor 240 for executing the processor-executable software instructions to determine the dynamic contact angle and a memory 250, operably coupled to the processor 240, for storing the processor-executable software instructions. A user interface 260 is operably coupled to the processor 240 and to the memory 250, and is operable for use by an operator for inputting a plurality of calculation parameters used by the processor-executable software instructions to calculate (determine) the contact angle of interest.

System 200 can further include, as part of the sessile drop apparatus, a sample stage (not shown, but known to those familiar with the art) for holding the curved material, and a dosing needle 270, operable to provide and maintain a controlled drop and a drop dosing rate. For in vivo contact angle determination, system 200 can further comprise a head support 280 for positioning the head of a subject wearing the curved material (e.g., a contact lens). For ex vivo dynamic contact angle determinations, the sample stage can replace the head support 280.

The contact angle measurements obtained in this study are referred to as dynamic contact angles due to the non-equilibrium conditions used throughout the studies. A sessile drop (water in-air) method was used to obtain the contact angles.

Sessile Drop Studies

The time taken for a contact angle measurement resulted in a contact lens air exposure time of 1.5 minutes. The procedure is as follows: The contact lens is either taken from its packaged buffered saline solution or pre-soaked in a solution using a tweezer and then inverted on a clean lens tissue paper with its anterior side in contact with the tissue for 30 seconds. This lens manipulation process allows residual liquid to collect and form a pool at the posterior apex location of the lens. The lens tissue in contact with the anterior apex lens location wicks away any residual liquid that could cause artifacts in the contact lens measurements. The contact lens is then carefully placed on the contact lens support using the tweezers, with its anterior side facing upwards and towards the dosing needle. The residual liquid that pools on the posterior side of the lens (during the 30 second timeframe) forms a film between the lens support surface and the lens, facilitating the positioning of the lens on the support. This small residual amount of liquid is important, as the Acuvue® lens can be easily torn when positioning it on the contact lens holder. The residual amount of liquid between the lens support and posterior side of the lens should not influence the contact angles in the time frame studied.

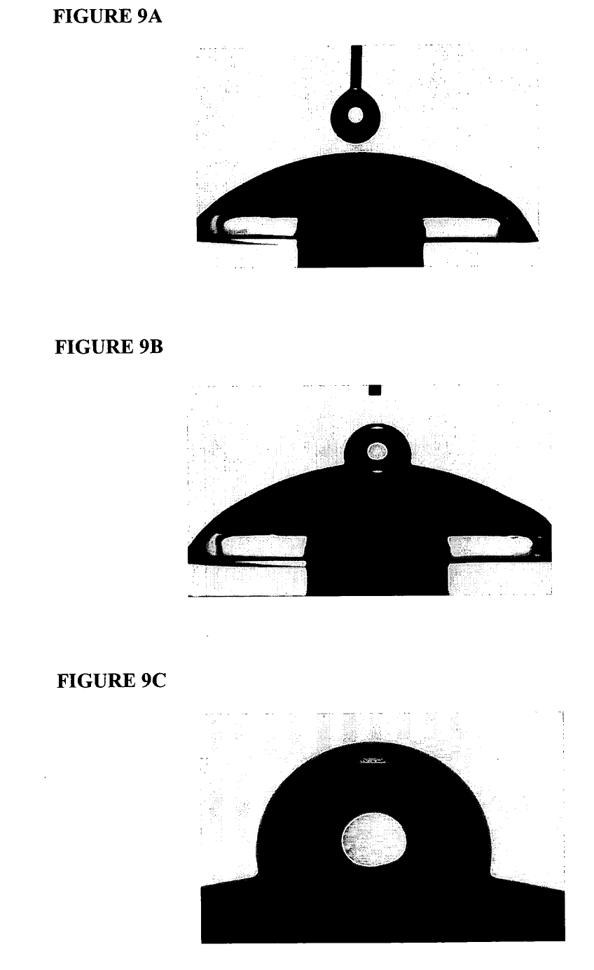

Subsequently, a water drop of 5 μl is formed on the tip of a dosing needle (e.g., Hamilton 500 μL DS 500/GT micro-syringe) positioned above the lens, at a controlled dosing rate of 2 μl s⁻¹ using an electronic syringe unit. This water drop is then transferred to the contact lens by moving the sample stage up gently towards the drop. The duration of contact between the lens and water (or liquid) drop is allowed to occur at about the one minute time frame. Once contact is made, a 10 second waiting time is used before calculating the contact angle. The lens is returned to a solution or used for other purposes at the 1.5 minute time marker. Due to the curved profile of the contact lens surface, a curved baseline profile-detection fitting algorithm resident in the software is used (SCA 20 software, Version 2.04, Build 4) to determine the contact angle. FIG. 9 provides a series of images illustrating the sessile drop method.

Two approaches were used to capture the drop image. One approach involves using a video recording function automatically triggered by the software program to record (at about 25 images s⁻¹) the water drop phenomena occurring on the contact lens surface. Any of the captured images can then be used to measure the contact angle(s). In another approach, the image is ‘grabbed’ using an image snapshot at the required time. Note that the curved baseline function is user defined and hence the reproducibility of the measured contact angle is user dependent in determining the best fit to the contact angle drop profile on a curved surface. However, the accuracy can be improved by adding more points along the image profile because the software can automatically correct its best fit (based on a least square difference method) to cover all the points. In other words, if the user selects enough points, the results can be as accurate as the Laplace-Young algorithm designed for drop on a flat surface. In all measurements, the left, right and mean contact angles are automatically calculated by the software. Three independent fitting measurements for each drop were recorded. The precision of the contact angle determinations on the curved lens is within ±3′. The sets of data obtained in this evaluation were reproduced at least twice to confirm the contact angle behavior.

It is important to note that the method described above is equally applicable to in vivo contact angle measurement with only slight modifications. An appropriate apparatus for supporting the human head of a contact lens wearing patient can be fitted to the contact angle measuring system and the contact angle measurements taken while the patient is wearing the contact lens. Such a modification is contemplated to be within the scope of this invention.

Ex Vivo Contact Angle Measurements

Ex vivo experiments were carried out as follows: A 36 year old male patient who regularly uses contact lenses wore contact lenses that were presoaked with various disinfection solutions. Table 5 shows the compositions of the marketed presoaking solutions that were used. Acuvue® 2 (BC 8.7; DIA 14.0; D +0.50) was worn on the left eye. Acuvue® Toric (BC 8.7; DIA 14.4; D +2.25) was worn on the right eye. The lenses were soaked for 12 hours and worn for 7 hours during the day. The lenses were removed from both eyes using rubber gloves and then manipulated using tweezers for the contact angle measurements. Prior to the contact angle measurements, each lens was soaked for 5 minutes in Unisol and then the contact angle of the lens was measured after 1.5 minute airtime. The results of the ex-vivo study are shown in Table 3 above.

TABLE 5
Lens Presoaking Solutions

| | Solution Contents as Listed by the Manufacturer | | |
|---|---|---|---|
| | | Buffers, Tonicity, | |
| | Biocides and | Protein Cleaning, | Surfactants and |
| Lens Solutions | Preservatives | Agents and Salts | Polymers |
| OPTI-FREE ® | POLYQUAD ® | Sodium citrate, | Tetronic ® 1304 |
| Express ® (Alcon) | (polyquaternium-1), | NaCl, boric acid, | |
| (MPDS) | ALDOX ® | sorbitol, and AMP- | |
| | (myristamidopropyl) | 95 | |
| | and EDTA | | |
| Renu MultiPlus ® | DYMED | Hydroxyalkyl | Poloxamine |
| (Bausch & Lomb) | (polyaminopropyl | phosphonate, boric | (Tetronic ® 1107) |
| (MPDS) | biguanide) and EDTA | acid, sodium borate | |
| | | and NaCl | |
| Complete ® | Polyhexamethylene | Phosphate, NaCl | Hydroxypropyl |
| Moisture Plus | biguanide and EDTA | and KCl | methylcellulose |
| (Advanced | | | and Poloxamer 237 |
| Medical Optics) | | | (Pluronic ® F87) |
| (MPS) | | | |
| Unisol ® 4 | none | NaCl, boric acid | none |
| | | and sodium borate | |

The present invention has been described by reference to certain preferred embodiments; however, it should be understood that it may be embodied in other specific forms or variations thereof without departing from its spirit or essential characteristics. The embodiments described above are therefore considered to be illustrative in all respects and not restrictive, the scope of the invention being indicated by the appended claims.

1. A method for determining a dynamic contact angle on a curved material, comprising:
initializing a video-based contact angle measuring apparatus;
preparing the curved material for contact angle measurement;
performing a sessile drop procedure to deposit a drop of liquid on the curved material;
capturing an image of the drop on the curved material at a preset time;
determining a drop-curved material interface on the image;
determining a drop profile on the image; and
calculating a set of dynamic contact angles based on the drop-curved material interface and the drop profile.

2. The method of claim 1, wherein initializing the contact angle measuring apparatus comprises inputting a set of calculation parameters to a software module of the contact angle measuring apparatus.

3. The method of claim 2, wherein the set of calculation parameters comprises at least one of a drop phase density, a needle size of a needle delivering the drop, aspect ratio, dosing rate and dosing volume.

4. The method of claim 1, wherein the contact angle measuring apparatus comprises a parfocal zoom lens charge coupled device camera and wherein initializing the contact angle measuring apparatus comprises:
preparing the camera to capture images;
initializing a software module and user interface; and
preparing a dosing needle for delivery of the drop.

5. The method of claim 1, wherein preparing the curved material comprises:
removing the curved material from a soaking solution;
removing excess soaking solution from an anterior side of the curved material; and
mounting the curved material on a sample stage with the anterior side positioned to receive the drop.

6. The method of claim 5, wherein the soaking solution is selected from the group of Unisol and a multi-purpose disinfecting solution.

7. The method of claim 1, wherein the curved material is a hydrogel contact lens.

8. The method of claim 1, wherein the drop of liquid is a drop of water.

9. The method of claim 1, wherein the image of the drop on the curved material is a single snapshot.

10. The method of claim 1, wherein the image of the drop on the curved material comprises a series of video images, and wherein any one image can be selected for use in calculating the set of dynamic contact angles.

11. The method of claim 1, wherein the preset time is in the range of about 5 to about 10 seconds after the drop is deposited on the curved surface.

12. The method of claim 1, wherein determining the drop-curved material interface comprises selecting a first plurality of points on the image where the drop and the curved material meet and providing the first plurality of points to a software module for curve-fitting the first plurality of points to generate a curve defining the drop-curved material interface and wherein determining the drop profile comprises selecting a second plurality of points on the image along the drop periphery and providing the second plurality of points to the software module for curve-fitting the second plurality of points to generate a curve defining the drop profile.

13. The method of claim 12, wherein the first and second plurality of points are manually selected via a user interface.

14. The method of claim 12, wherein the software module comprises a curved baseline profile-detection fitting algorithm.

15. The method of claim 1, wherein the set of dynamic contact angles comprises at least one of a left contact angle, a right contact angle and a mean contact angle.

16. The method of claim 14, wherein the right contact angle is the contact angle of the drop to the curved material on the right side of the image, the left contact angle is the contact angle of the drop to the curved material on the left side of the image and the mean contact angle is the average of the left contact angle and the right contact angle.

17. The method of claim 1, wherein the contact angle measuring apparatus comprises:
a processor;
a software module comprising processor-executable software instructions for performing at least some of the steps of the method; and
a memory, operably coupled to the processor, for storing the processor executable software instructions.

18. The method of claim 1, wherein determining the drop-curved material interface, determining the drop profile, capturing an image, initializing the contact angle-measuring apparatus and calculating the set of dynamic contact angles are each at least partially performed via software running on a processor.

19. The method of claim 18, wherein the software comprises a curved baseline profile-detection fitting algorithm.

20. The method of claim 1, wherein the contact angle measuring apparatus further comprises a frame-grabber for capturing the image.

21. The method of claim 1, wherein the curved material is a hydrogel contact lens on an eye and wherein the dynamic contact angles are measured while the contact lens is worn on the eye.

22. The method of claim 21, wherein the contact angle measuring apparatus further comprises a head support for positioning the head of a subject wearing the contact lens.

23. A system for determining a dynamic contact angle on a curved material, comprising:
a sessile drop apparatus for depositing a drop of liquid on the curved material;
a video capture system for capturing an image of the drop on the curved material at a preset time;
a software module, comprising processor-executable software instructions for performing at least some of the steps of determining the dynamic contact angle;
a processor for executing the processor-executable software instructions to determine the dynamic contact angle;
a memory, operably coupled to the processor, for storing the processor-executable software instructions; and
a user interface, operably coupled to the processor and to the memory, for inputting a plurality of calculation parameters for use by the processor-executable software instructions.

24. The system of claim 23, wherein the sessile drop apparatus further comprises a sample stage for holding the curved material and a dosing needle, operable to provide and maintain a controlled drop and a drop dosing rate.

25. The system of claim 24, wherein the plurality of calculation parameters comprises at least one of a drop phase density, a needle size of the dosing needle delivering the drop, a video aspect ratio, the drop dosing rate and a dosing volume.

26. The system of claim 23, wherein the video capture system comprises a parfocal zoom lens charge coupled device camera and a frame-grabber for capturing the image.

27. The system of claim 23, wherein the curved material is a hydrogel contact lens.

28. The system of claim 23, wherein the drop of liquid is a drop of water.

29. The system of claim 23, wherein the image of the drop on the curved material is a single snapshot.

30. The system of claim 23, wherein the image of the drop on the curved material comprises a series of video images, and wherein any one image can be selected for use in determining the set of dynamic contact angles.

31. The system of claim 23, wherein the preset time is in the range of about 5 to about 10 seconds after the drop is deposited on the curved surface.

32. The system of claim 23, wherein the user interface is operable to determine a drop-curved material interface on the image and to determine a drop profile on the image, and wherein the processor and the processor-executable software instructions are operable to determine the dynamic contact angle based on the drop-curved material interface and the drop profile.

33. The system of claim 32, wherein determining the drop-curved material interface comprises selecting a first plurality of points on the image where the drop and the curved material meet and providing the first plurality of points to the software module for curve-fitting the first plurality of points to generate a curve defining the drop-curved material interface and wherein determining the drop profile comprises selecting a second plurality of points on the image along the drop periphery and providing the second plurality of points to the software module for curve-fitting the second plurality of points to generate a curve defining the drop profile.

34. The system of claim 33, wherein the first and second plurality of points are manually selected via the user interface.

35. The system of claim 23, wherein the software module further comprises a curved baseline profile-detection fitting algorithm.

36. The system of claim 23, wherein the dynamic contact angle comprises at least one of a left contact angle, a right contact angle and a mean contact angle.

37. The system of claim 23, wherein the curved material is a hydrogel contact lens on an eye and wherein the dynamic contact angle is measured while the contact lens is worn on the eye.

38. The system of claim 37, further comprising a head support for positioning the head of a subject wearing the contact lens.
